(19) United States
(12) Patent Application Publication
(10) Pub. No.: US 2019/0159973 A1
(43) Pub. Date: May 30, 2019

(54) TEETHING DEVICE

(71) Applicant: Matchstick Monkey Limited, London (GB)

(72) Inventor: Katherine WINDRIDGE, Braunton (GB)

(73) Assignee: Matchstick Monkey Limited, London (GB)

(21) Appl. No.: 16/320,661

(22) PCT Filed: Jul. 25, 2017
(86) PCT No.: PCT/GB2017/052163

§ 371 Date: Jan. 25, 2019

(30) Foreign Application Priority Data
Jul. 26, 2016 (GB) 1612940.5

(51) Int. Cl. A61J 17/02; A46B 5/02

(52) U.S. Cl. CPC A61J 17/02; A61J 17/006; A46B 5/023

(57) ABSTRACT

An improved teething device is provided. The device comprises a body portion (3) and a head portion (5) extending from the body portion. A plurality of nodules (11) project from a surface (9) of the head portion (5).

### FIELD OF THE INVENTION

The present invention is directed to devices for treating the mouth, and is more specifically a teething device intended for use by young children whilst they are teething.

### BACKGROUND OF THE INVENTION

Teething rings and similar devices are known and are intended for use by young children whilst they are teething. These devices are typically formed at least in part from a compressible material such as an elastomer or gel-filled plastics material. The child chews on the compressible material so as to ease the pain and discomfort in the areas of the gums where teething is taking place. Those devices which are gel-filled may be placed in a refrigerator or freezer so that the gum area is also cooled whilst the child is chewing on the device.

It is typically the incisors at the front of an infant's mouth which break through the gums first at around 8-13 months old. However, a great deal of the discomfort which occurs during teething is actually caused by the larger molars towards the rear of the mouth which do not tend to break through until anywhere between 13 and 33 months old. Whilst a child can readily chew on the aforementioned devices to ease discomfort at the front of the mouth, it is often not possible for rings and other such devices to access the rear of the child's mouth. Thus the pain and discomfort being experienced towards the rear of the mouth may not be eased by these known devices.

Teething medication in the form of gels and powders are also known and are intended to be applied directly to the gums of the child. This can be done by putting the medication on the finger of a parent or carer, with the finger then being rubbed on the child's gum. Alternatively, the medication can be placed on a teething ring or similar teething device and the device is then simply given to the child for them to chew on. Whether placed on a finger or teething device it is difficult to keep the medication upon the finger or device long enough for it to reach the rearmost areas of the mouth. As soon as the finger or device enters the mouth the medication tends to come off at one single location, or else the child will just suck the entire amount of medication away immediately. In addition, if the medication is being applied using a finger, the carer can experience discomfort themselves if the child already has a number of teeth and is chewing down on the finger.

It is an aim of the present invention to obviate or mitigate the aforementioned disadvantages of existing teething treatments and devices.

### SUMMARY OF THE INVENTION

According to the present invention, there is provided a teething device comprising a body portion, a head portion extending from the body portion, and a plurality of nodules projecting from a surface of the head portion.

A “nodule” is a lump or protuberance having a rounded top and a comparatively short height, or length, in comparison to the bristles found on toothbrushes and other teething devices, for example.

Each nodule may have a diameter D, and wherein the nodules are arranged on the surface of the head portion such that the distance between any two adjacent nodules is equal to or less than D. Most preferably, the distance between any two adjacent nodules is less than D.

Each nodule projects a height H from the surface of the head portion, where H may be no more than twice the diameter D.

The plurality of nodules may be arranged in a plurality of rows which extend transversely across the head portion. Alternatively, the rows may extend longitudinally along the head portion.

The body portion may be elongate, and the head portion may extend in a substantially longitudinal direction from the body portion.

The device may further comprise at least one handle member extending outwardly from the body, the at least one handle member having first and second ends attached to the body portion at spaced apart locations. Most preferably, the device further comprises a pair of such handle members extending outwardly from opposing sides of the body portion.

### BRIEF DESCRIPTION OF THE DRAWINGS

A preferred embodiment of the present invention will now be described, by way of example only, with reference to the following drawings:

FIGS. 1-3 show front, rear and side views respectively of an improved teething device; and

FIGS. 4 and 5 are detail views of areas of the head portion of the device marked “IV” and “V” in FIGS. 2 and 3.

### DETAILED DESCRIPTION OF THE DRAWINGS

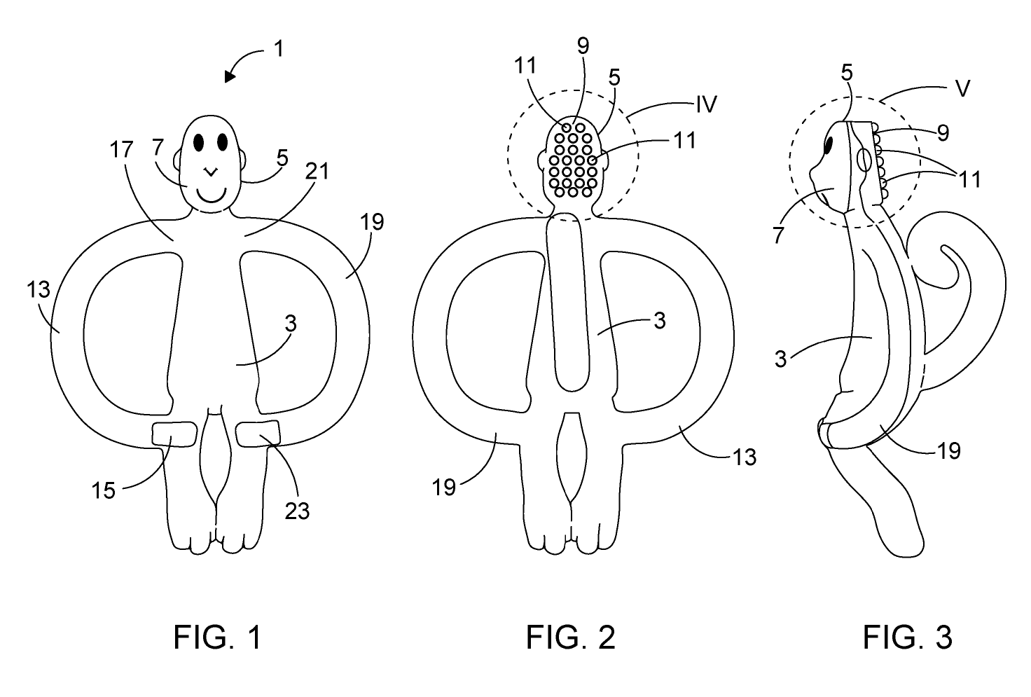

An improved teething device, generally designated 1, is shown in FIGS. 1-5. The device 1 is preferably moulded in a single piece from an appropriate compressible material such as, for example, food grade silicone rubber. The device 1 comprises a body portion 3 and a head portion 5 extending from the body portion. In a preferred embodiment, and as illustrated, the device is formed in the shape of an animal (e.g. monkey, giraffe) so as to be attractive to a young child. However, the present invention is not limited to this specific arrangement. The body portion 3 may be elongate, and the head portion 5 may extend longitudinally from the body portion 5.

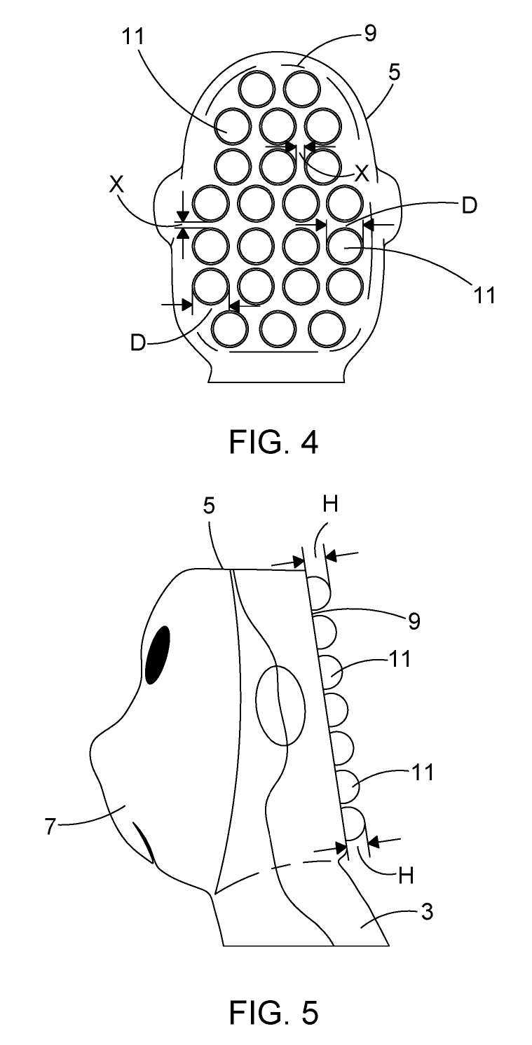

The head portion 5 has a lower surface 7 which in the illustrated embodiment has the face of an animal formed thereon. An upper surface 9 of the head portion is preferably planar and has a plurality of nodules 11 formed thereon. As best seen in FIG. 4, each nodule 11 may have a diameter D, and the nodules 11 may be arranged on the upper surface 9 of the head portion 5 such that the distance X in the longitudinal and/or transverse directions between any two adjacent nodules 11 is equal to or less than D. Most preferably, the distance X between any two adjacent nodules is less than D.

As best seen in FIG. 5, each nodule 11 projects a height H from the upper surface 9 of the head portion 5. The height H is preferably no more than twice the diameter D. Referring again to FIGS. 2 and 4, the plurality of nodules 11 may be arranged in a plurality of rows which extend transversely across the head portion 5. Alternatively, the plurality of rows may extend longitudinally along the head portion 5.

The device 1 may further comprise at least one handle member 13,19 extending outwardly from the body portion 3, where the at least one handle member 13,19 has a first end 15,21 and a second end 17,23 attached to the body portion 3 at spaced apart locations. As illustrated, the device most preferably further comprises a pair of such handle members 13,19 extending outwardly from opposing sides of the body portion 3.

### INDUSTRIAL APPLICABILITY

In use, the device can be used with a teething child simply chewing upon the compressible head portion 5 and nodules 11 to ease their discomfort. However, most preferably a teething medication such as a teething gel or powder is applied to the upper surface 9 of the head portion 5. The medication will disseminate and fill the gaps between the nodules 11 and thus be retained on the head portion 5 by the nodules. The child can then place the head portion in its mouth and chew upon the head portion and in so doing apply the medication to an area of the gums where pain or discomfort is present.

By placing a plurality of nodules upon the head portion of the device, the present invention provides not only a basic teething device but also one in which a teething medication can be effectively retained upon the device in order to treat a child's gums. Having a head portion which extends longitudinally from the body portion ensures that the child can reach both the front and rear gum areas of the mouth rather than just chewing using the frontal gum area. Having the nodules relatively close to one another ensures that medication is retained on the device long enough to treat both the front and rear gum areas as well, rather than the medication falling or being sucked from the device before it can treat the rearmost gum areas. The present invention also avoids a parent or carer having to place a finger in the child's mouth, which can result in discomfort should the child already have a number of teeth. Utilising relatively short nodules instead of bristles also ensures that there is no risk of the child choking on the longer bristles whilst using the device. The nodules also ensure that any gel or powder placed on the head of the device can still be applied effectively to the gums of the child, as opposed to falling down between long bristles where the treatment may not end up on the child's gums.

As well as a teething device, the present invention may also be used as a training toothbrush for young children who are learning how to brush their teeth, with the short nodules gently removing formations from the teeth and gums. Similarly to teething medication, toothpaste can be held in the gaps between the nodules.

The device may include a neck or web portion which connects the head portion to the body portion.

Other modifications and improvements may be incorporated without departing from the scope of the invention.

1. A teething device comprising:
a body portion;
a head portion extending from the body portion; and
a plurality of nodules projecting from a surface of the head portion.

2. The teething device of claim 1, wherein each nodule has a diameter D, and wherein the nodules are arranged on the surface of the head portion such that the distance between any two adjacent nodules is equal to or less than D.

3. The teething device of claim 2, wherein the distance between any two adjacent nodules is less than D.

4. The teething device of claim 2, wherein each nodule projects a height H from the surface of the head portion and H is no more than twice the diameter D.

5. The teething device of claim 1, wherein the plurality of nodules are arranged in a plurality of rows which extend transversely across the head portion.

6. The teething device of claim 1, wherein the plurality of nodules are arranged in a plurality of rows which extend longitudinally along the head portion.

7. The teething device of claim 1, wherein the body portion is elongate and the head portion extends in a substantially longitudinal direction from the body portion.

8. The teething device of claim 1, comprising at least one handle member extending outwardly from the body, the at least one handle member having first and second ends attached to the body portion at spaced apart locations.

9. The teething device of claim 1, comprising a pair of handle members extending outwardly from opposing sides of the body portion, each handle member having first and second ends attached to the body portion at spaced apart locations.
